(19) United States
(12) Patent Application Publication
(10) Pub. No.: US 2023/0306935 A1
(43) Pub. Date: Sep. 28, 2023

(54) GUITAR COVER FOR A GUITAR WALL HANGER

(71) Applicants: William John Lydon, JR., Dyersburg, TN (US); Sherry Darlene Lydon, Dyersburg, TN (US); Reid Hardin Lydon, Dyersburg, TN (US)

(72) Inventors: William John Lydon, JR., Dyersburg, TN (US); Sherry Darlene Lydon, Dyersburg, TN (US); Reid Hardin Lydon, Dyersburg, TN (US)

(21) Appl. No.: 17/705,134

(22) Filed: Mar. 25, 2022

(51) Int. Cl. G10G 5/00

(52) U.S. Cl. CPC G10G 5/00

(57) ABSTRACT

Present invention specifically relates to a GUITAR COVER FOR A GUITAR WALL HANGER. The wall hanger is the most popular way of parking a guitar for three reasons: Ease of accessibility, keep from being damaged, and for displaying the guitar. The present invention solves the problem incurred by a guitar wall hanger because said prior art does not offer said guitar any protection from the elements or from physical damage. The present invention still allows the guitar to be seen by way of the front panel that can be made of a transparent material such as clear vinyl. The present invention is stationary to the prior art so that the guitar cover remains in place, even when the guitar is removed from the wall hanger. This is accomplished by using at least one zipper located on the cover's edge for easy access to the guitar.

### BACKGROUND OF THE PRESENT INVENTION

### 1. Field of the Invention

The present invention relates to the guitar which is one of the most popular musical instruments ever invented. More specifically, the present invention relates to a guitar cover to protect the guitar as it is parked or “hung” on a typical guitar wall hanger.

### 2. Description of the Related Arts

The most widely used form of parking or storing a guitar is on a guitar wall hanger, also referred to herein as the “prior art.” The most common reason for this preference is because people like for their instrument to be displayed up high for others to see. And what better way to accomplish this than to display it on a wall like a picture frame or any other type of wall decoration to be admired. The use of a guitar wall hanger also provides easy access to the guitar compared to other means such as storing it in a guitar case which is usually kept on the floor, under a bed, or in a closet.

Alternatively, another form of parking a guitar when not in use is on a typical guitar floor stand. A guitar floor stand does indeed allow easier access to the instrument than a guitar case but still leaves the guitar vulnerable to being knocked over or damaged due to being left so close to the floor. Two different types of guitar covers specifically designed for use with guitar floor stands are expressed by U.S. Pat. Nos. 6,441,288 B1 and 7,956,270 B1. Neither of these designs were meant for, nor do they even claim to work with a guitar wall hanger.

### SUMMARY OF THE PRESENT INVENTION

The present invention is a GUITAR COVER FOR A GUITAR WALL HANGER. The guitar cover is specifically designed to enhance the functionality of a typical guitar wall hanger. The present invention solves the problem incurred by a typical guitar wall hanger because the prior art does not offer any protection from the elements or possible physical damage to a guitar while the instrument is parked on the wall hanger. The present invention still allows the guitar wall hanger to display the guitar by way of the fully or partially transparent front panel. The present invention is mounted in a stationary fashion to the wall hanger so that at least, but not limited to, the portion of the wall hanger on which the guitar hangs, also known as a “yoke cradle”, is sandwiched between the front and rear panels of the present invention. The guitar is quickly retrieved and returned to the wall hanger from between said front and back panels by unzipping at least one zipper slider on the cover's edge located between the front and back panels. The amount of zippered material used compared to the amount of non-zippered material used is not limited to any geographical portion of the guitar cover's perimeter; but instead, the zippered material can be located around as much as the entire perimeter of the cover's front and back panels.

### BRIEF DESCRIPTION OF THE DRAWINGS

FIG. 1 is a perspective view of a guitar parked on a typical guitar wall hanger. Included is a detailed view of the guitar wall hanger's three components. These are the base, the two screws to attach the base to a wall, and the guitar hanger which is screwed into the center hole of the base.

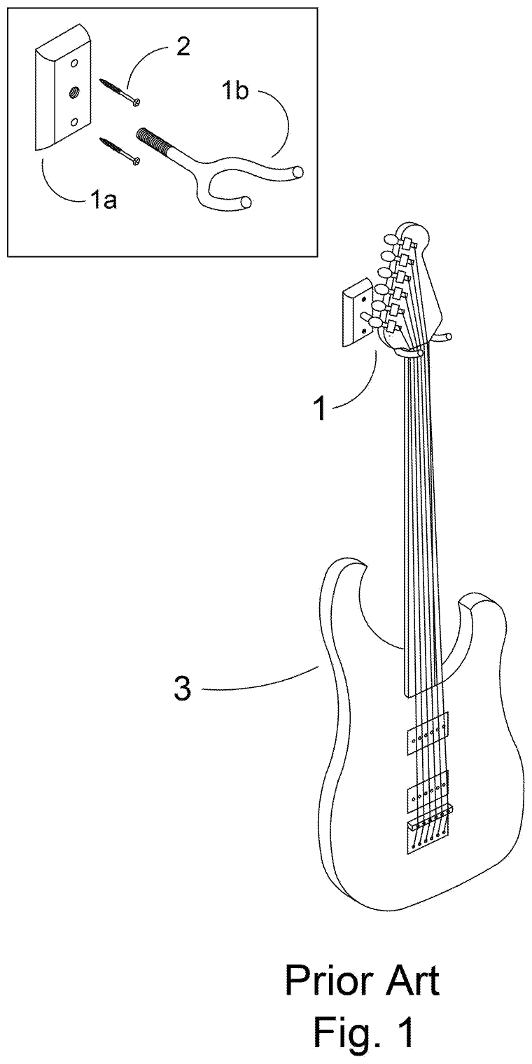

FIG. 2 is a perspective view of a guitar cover protecting a guitar while said guitar is parked or “hung” on a typical guitar wall hanger.

FIG. 3 is a perspective view of a guitar cover affixed to a typical guitar wall hanger as the present invention would look when a guitar is absent from being parked on the wall hanger.

FIG. 4 is an exploded perspective view displaying each component of the present invention as well as each component of the prior art.

FIG. 5 is an exploded perspective view of an alternate method of attaching the present invention to the prior art.

FIG. 6 is an exploded perspective view of another alternate method of attaching the present invention to the prior art.

FIG. 7 is a perspective view of an alternate method of using zippered material around the entire perimeter of the guitar cover's front and back panels. It also depicts an alternate example of a partially transparent front panel.

### DETAILED DESCRIPTION OF THE PREFERRED EMBODIMENT

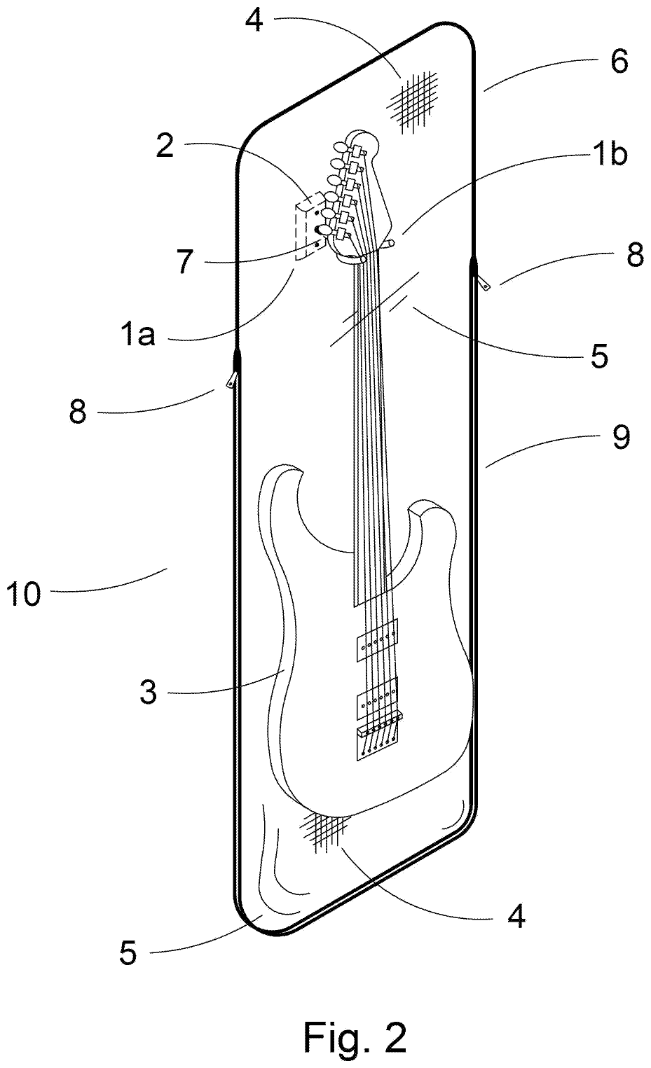

Referring to FIG. 2 of the drawings, a guitar cover comprised of its front panel 5, its back panel 4, two zipper sliders 8, their zipper binding material 9, the non-zipper binding material 6, and reinforced hole 7 located in the center of the back panel's 4 width. The wall hanger is comprised of its base 1a, the two screws to attach the base to a wall 2, and the guitar hanger 1b. The guitar cover 10 is affixed to the wall hanger 1 by first removing the guitar hanger 1b from the base 1a. The hanger 1b is then inserted through the reinforced hole 7 in the back panel 4 of the cover 10. Then the guitar hanger 1b is screwed back into the wall hanger base 1a; thus, securing the guitar cover 10 to the wall hanger 1. The guitar hanger 1b is the portion of the wall hanger 1 on which the guitar 3 is parked or “hung.” The guitar 3 is hung on the guitar hanger 1b by way of an unzipped portion of the zippered binding material 9.

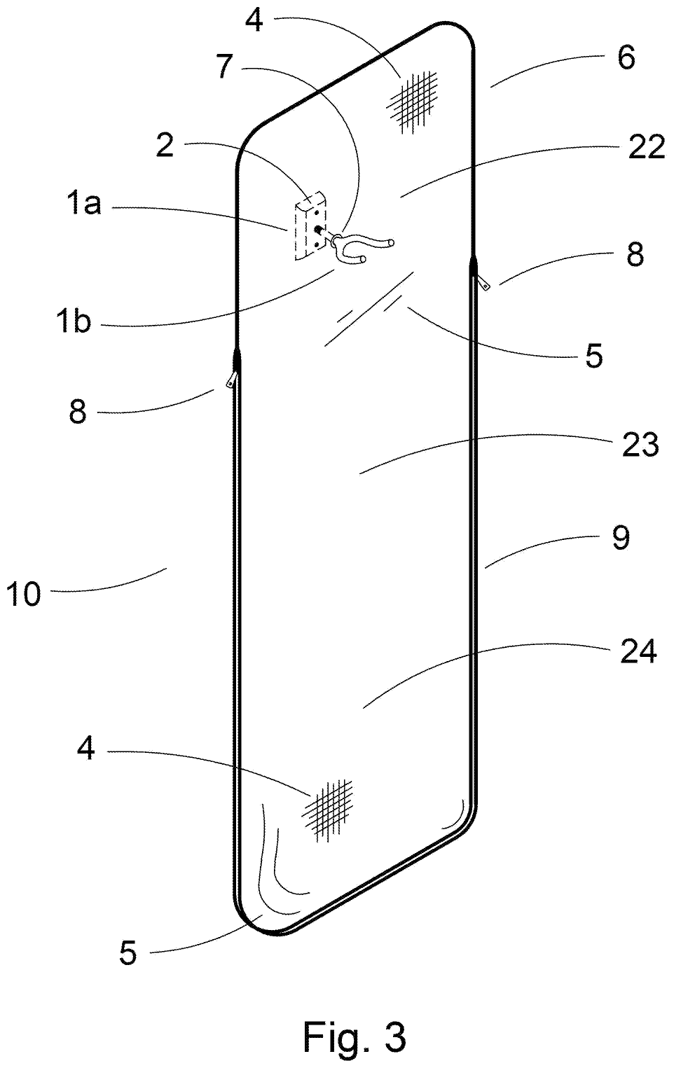

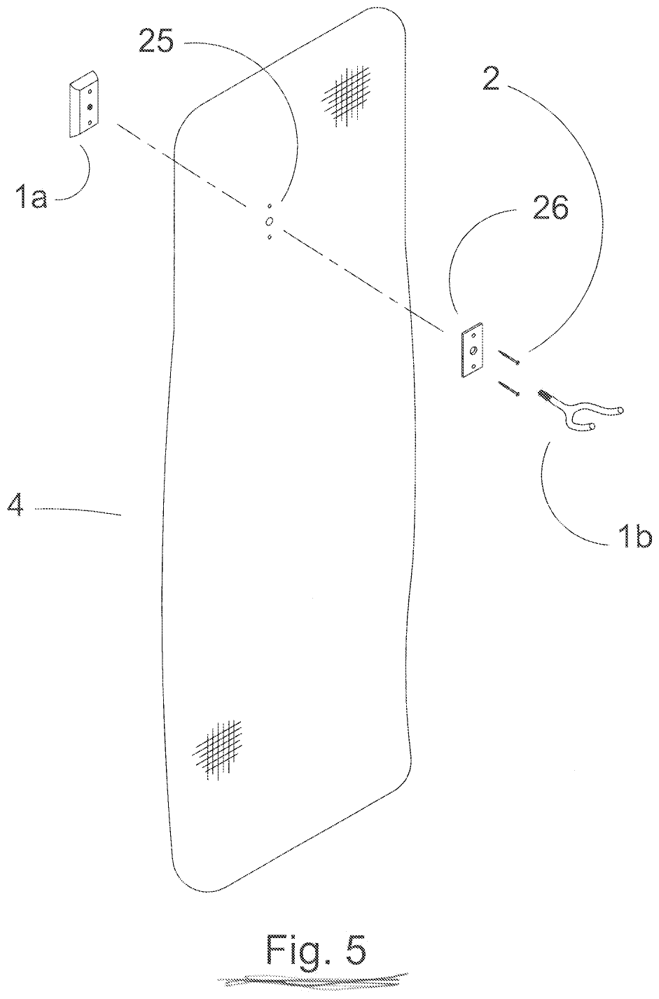

Referring to FIG. 3 of the drawings, a guitar cover 10 comprised of its front panel 5, its back panel 4, two zipper sliders 8, their zipper binding material 9 located along the edges of the middle portion 23 and lower portions 24, the non-zipper binding material 6 located along the edges of the upper portion 22, and reinforced hole 7 also located in the upper portion 22 and centered in the width of the back panel 4. The reinforced hole 7 can be but is not limited to be the sole means by which the guitar cover 10 is attached to the wall hanger 1. An example of a method that is not limited to said sole means of attachment is shown on FIG. 5. The wall hanger is comprised of its base 1a, the two screws to attach the base to a wall 2, and the guitar hanger 1b. The guitar cover 10 is affixed to the wall hanger 1 by first removing the guitar hanger 1b from the base 1a. The hanger 1b is then inserted through the reinforced hole 7 in the back panel 4 of the cover 10. Then the guitar hanger 1b is screwed back into the wall hanger base 1a; thus, securing the guitar cover 10 to the wall hanger 1.

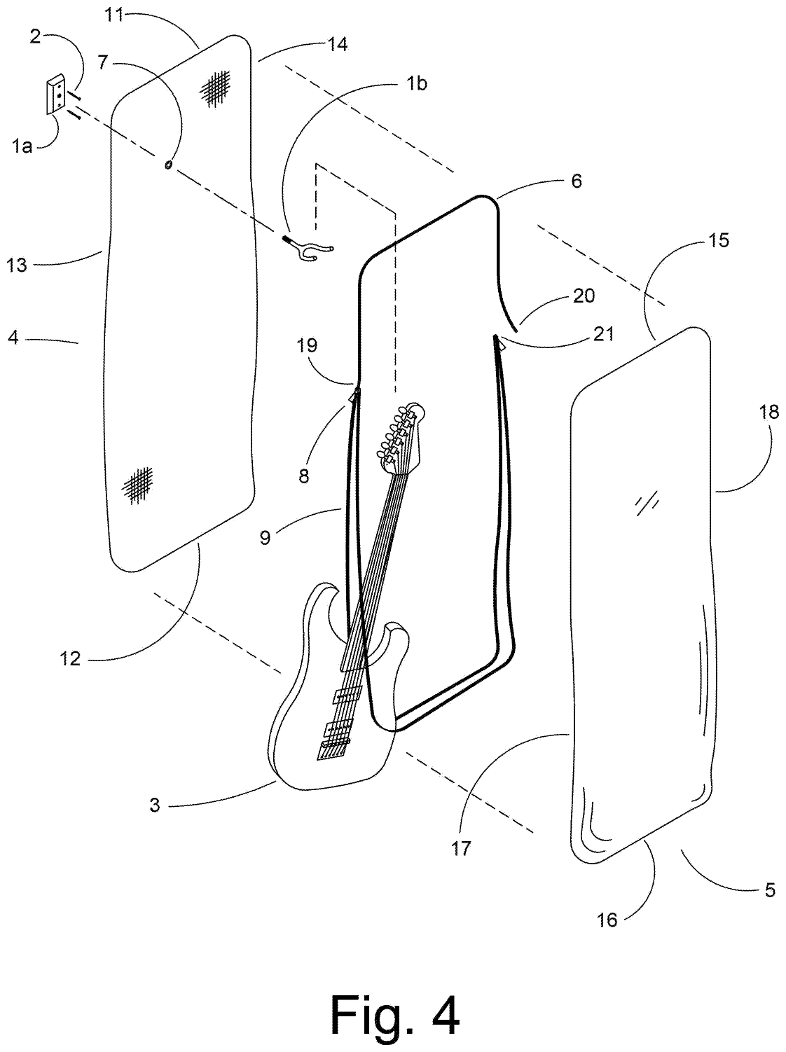

Referring to FIG. 4 of the drawings, depicts an exploded view of the present invention and of the prior art. Starting from the left the drawing shows the wall hanger base 1a with the two wall screws 2 that anchor the wall base 1a to a wall. Next is the back panel 4 which is made of a type of material or a combination of materials suitable to protect and cover a guitar. The back panel 4 is made, but is not limited to, a shape large enough for a guitar and contains a reinforced hole 7 located in the upper portion 22 (FIG. 3) of the back panel 4 for which the entire cover is supported by, and attached to, the guitar hanger 1b.

The overall shape of the back panel 4 is comprised of a top edge 11, a bottom edge 12, a left edge 13, and a right edge 14. Next is the non-zippered binding material 6 that is shown on the upper portion 22 (FIG. 3) of the present invention which binds the front panel 5 to back panel 4.

To bind the middle portion 23 and lower portion 24 (FIG. 3) of the present invention together, a zippered material 9 is used with two zipper sliders 8 shown. The front panel 5 is also made of any type of material suitable to protect and cover a guitar but can also be preferably made using a transparent or translucent type of material so that the guitar 3 can be seen through the cover as the guitar 3 is displayed on a guitar wall hanger 1.

The front panel 5 is generally cut, but is not limited to, the same overall pattern as the back panel 4 containing a top edge 15, a bottom edge 16, a left edge 17, and a right edge 18. The said four edges of back panel 4 will be sewn to the said four edges of front panel 5 in a respective manner. This is accomplished by attaching the upper portion 22 (FIG. 3) of the right edge 14 to the right edge 18 together using non-zippered material 6. Then continuing around with the same non-zippered material 6, sew top edge 11 to top edge 15. Then again, continue to sew with the same non-zippered material 6 around to the left edge 13 binding it to left edge 17 for the upper portion 22 (FIG. 3) of the present invention.

From where the non-zippered material stops 19, begin sewing the remaining middle portion 23 and lower portion 24 (FIG. 3) of left edge 13 to left edge 17 using zippered material 9. Also continuing around to the bottom sew together the bottom edge 12 to bottom edge 16 using zippered material 9.

Lastly, continue to sew back around to the right edge. This will conclude by attaching the lower portion 24 and middle portion 23 (FIG. 3) of the right edge 14 to the right edge 18 using zippered material 9 until the end 21 of the zippered material 9 is attached to the beginning 20 of the non-zippered material 6.

In conclusion, the guitar 3 is shown being inserted through the unzipped opening in the zippered material 9 so that it can be raised up into the guitar cover 10 (FIG. 2) and parked or “hung” on the guitar hanger 1b behind front panel 5 and in front of back panel 4 inside the present invention. The two zipper sliders 8 can then be pulled down to meet each other at any given point; thus, accomplishing the purpose of the present invention by completely protecting the guitar 3.

Referring to FIG. 5 of the drawings, depicts an exploded perspective view of an alternate method of attachment of the back panel 4 using a separate trim plate 26. The upper and lower holes in said trim plate are in direct alignment with the holes in the wall hanger base 1a so that the screws 2 are used to attach said trim plate 26 to said wall hanger base and into the wall on which said wall hanger base is being attached by passing through corresponding holes 25 made in back panel 4. After which, guitar hanger 1b is then inserted through said trim plate and said back panel and then threaded into said wall base.

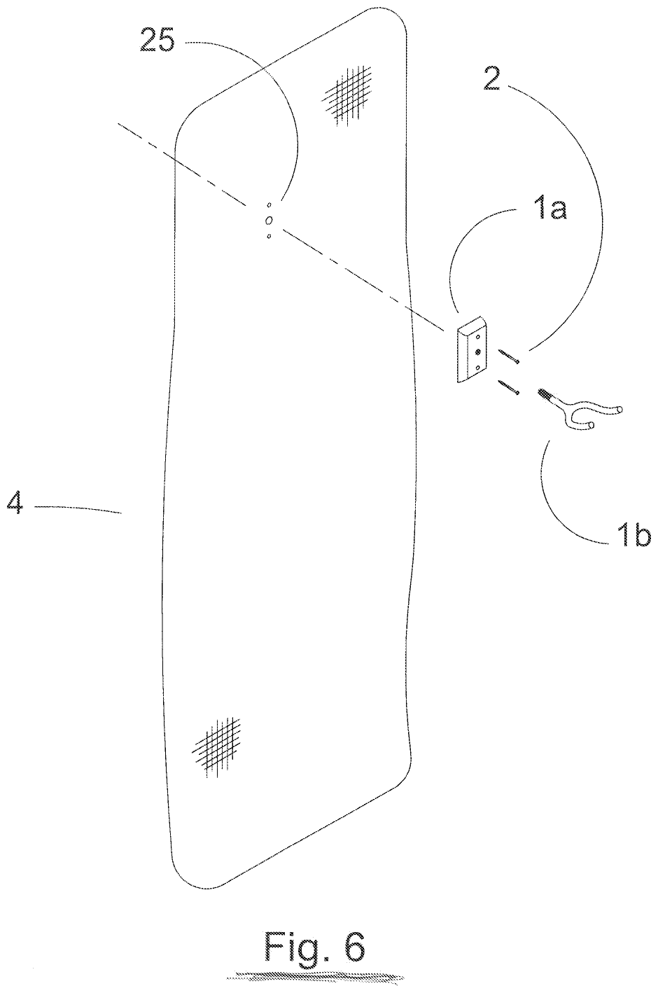

Referring to FIG. 6 of the drawings, depicts an exploded perspective view of an alternate method of attachment of the back panel 4 by securing said back panel with the wall hanger screws 2 so that said back panel is sandwiched between the wall base 1a and the wall on which said wall base is being attached. This is done by aligning the corresponding holes 25 in the upper portion of said back panel with the holes in said wall base.

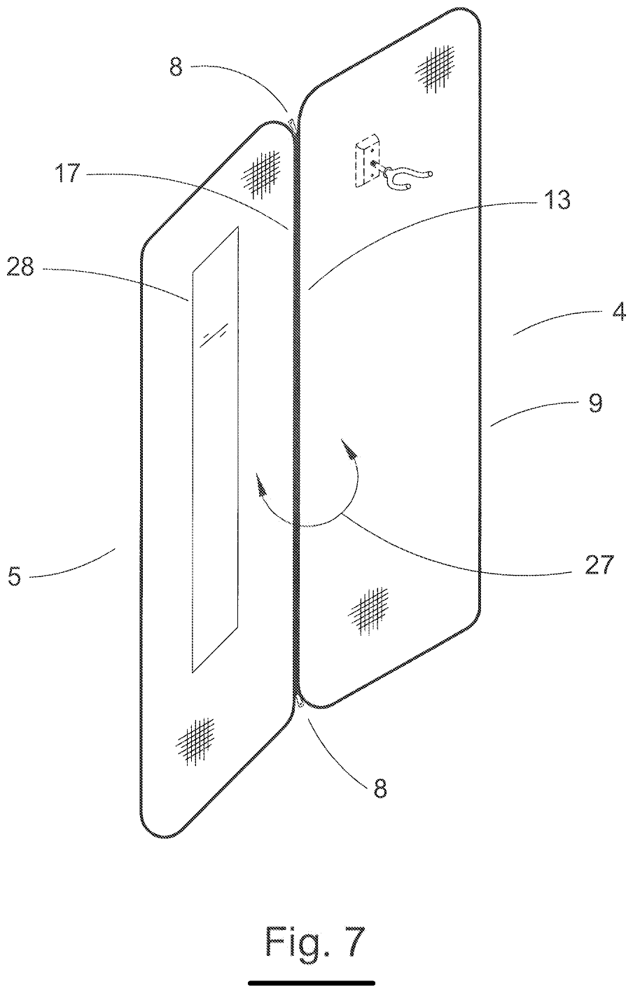

Referring to FIG. 7 of the drawings, depicts an alternate method of opening up the front panel 5 from the back panel 4 by way of what is known in the textile industry as a “zippered hinge” 27. For this example, said “hinge” 27 is made up of attaching the vertical edge 17 of front panel 5 to the vertical edge 13 of said back panel 4. This allows the zippered material 9 to be attached around at least three sides of said front and back panels to allow the said front and back panels to be opened up, one from another like opening the zippered front of a suitcase. FIG. 7 also depicts an alternate method of only displaying a portion of a guitar through an area 28 smaller than the overall size of the said front panel. This specific example depicts a tall, narrow window, centered in the width of said front panel 4.

### REFERENCES CITED

### U.S. Patent Documents

U.S. Pat. No. 6,441,288 B1 August 2002 Lin . . . 84/453
U.S. Pat. No. 7,956,270 B1 June 2011 Burmeister . . . 84/453

### Primary Examiner:

### Assistant Examiner:

### (74) Agent Pro Se: William John Lydon, Jr.

What is claimed is:

1. A GUITAR COVER FOR A GUITAR WALL HANGER. The guitar wall hanger is comprised of three components. They are the base, the anchor screws, and the guitar hanger bracket. The base is used to anchor said guitar wall hanger to a vertical surface such as a wall using anchor screws. The guitar hanger bracket is most commonly designed to have a threaded stud on one end that screws into the center of the said base. The other end of the said hanger bracket is forked in such a manner so that the said fork can receive the neck of a guitar; thus, allowing the headstock of the guitar to come to rest within the said fork of said hanger bracket, wherein said guitar cover is comprised of:
any kind of material of an appropriate size and shape capable of covering a guitar (or any other kind of stringed musical instrument), to any degree (partially or fully), that is used in conjunction with a device designed to hang a guitar (or any other kind of stringed musical instrument) on or suspended from a wall such as said guitar wall hanger.

2. The guitar cover as recited in claim 1, wherein said cover is further comprised of having a front panel and a back panel that is attached to a device used to hang a guitar on a wall like said guitar wall hanger so that said guitar wall hanger, or a portion thereof, is located between said front panel and the wall on which the said guitar wall hanger is attached.

3. The guitar cover as recited in claim 2, wherein said cover is further comprised of having said front panel and said back panel connected to each other along their respective edges that is attached to a device used to hang a guitar on a wall like said guitar wall hanger so that the said guitar wall hanger, or a portion thereof, is located between said front panel and the wall on which the said guitar wall hanger is attached.

4. The guitar cover as recited in claim 3, wherein said cover is further comprised of having said front panel and said back panel connected to each other using any combination of zippered material and/or non-zippered material along their respective edges and then said cover being attached to said guitar wall hanger so that the said guitar wall hanger, or a portion thereof, is located between said front panel and the wall on which the said guitar wall hanger is attached.

5. The guitar cover as recited in claim 4, wherein said cover is further comprised of having at least one opening in the upper portion of said back panel designed for the insertion of said guitar hanger bracket. With said hanger bracket removed from said base, said guitar cover is then attached to said guitar wall hanger by inserting said removed hanger bracket through the opening in said back panel so that said hanger bracket can then be re-engaged back into said base.

6. The guitar cover as recited in claim 2, wherein said cover is further comprised of having said front panel of which can be made of a transparent or translucent type of material such as clear vinyl. Said front panel material is made large enough that it allows as much as the entire front view of said guitar so that it can be but is not limited to be completely unobstructed from being clearly seen by obstructive things like front zippers or any other type of front fasteners or overlapping material as said guitar is displayed within said cover on said guitar wall hanger.
